(19) United States
(12) Patent Application Publication
(10) Pub. No.: US 2014/0135193 A1
(43) Pub. Date: May 15, 2014

(54) ASSEMBLY AND STRUCTURING SYSTEM BASED ON CORRUGATED AND LAMINATED CARDBOARD

(71) Applicant: Luis Albarran-Torres, Tlalnepantla (MX)

(72) Inventor: Luis Albarran-Torres, Tlalnepantla (MX)

(21) Appl. No.: 14/113,165

(22) PCT Filed: Mar. 22, 2012
(86) PCT No.: PCT/MX2012/000029

§ 371 Date: Dec. 31, 2013

(30) Foreign Application Priority Data
Mar. 22, 2011 (MX) MX/A/2011/003086

(51) Int. Cl. B31D 5/00

(52) U.S. Cl. CPC B31D 5/00
USPC 493/390

(57) ABSTRACT

System assembly and structure consisting of the inclusion of pieces of laminated cardboard in slots die-cut on corrugated panels to obtain three-dimensional structures very strength with regard to the materials used, as well as lightweight and self-supported. The applications are a plurality, ranging from items of furniture such as chairs, tables, beds, elements of load of products or displays, packaging; until construction elements such as attics mezzanines. In addition the assembly system is designed to be armed with practical and easy way for the user, without the need to use tools. This allows and facilitates the transport of structures exploded accommodated in a compact way, occupying a relatively small space.

### CROSS REFERENCE TO RELATED APPLICATIONS

This patent application is a national stage entry of, and claims priority to, international patent application number PCT/MX2012/000029, filed Mar. 22, 2012, which claims priority to Mexican utility patent application number MX/a/2011/003086, filed Mar. 22, 2011.

### FIELD OF THE INVENTION

The present invention relates to the field of systems of building structures based on sustainable materials, in particular to the assembly of pieces of cardboard in two main types: corrugated and laminated cardboard, more specifically to the combination of both cardboards for the construction of structures that form furniture, packaging and self-supported structures.

### BACKGROUND OF THE INVENTION

There are structures built from sheets of corrugated cardboard, such as boxes and displays with a variety of presentations on the state of the art. They obtain a considerable structural strength due to folds, tabs, tongue and slots that accommodate them to form interlocking locks that prevent folding or deformation of three-dimensional structures.

With regard to generally laminated cardboard is used to give support to the packaging of the final product, used as a corner pieces that does not form part of the structure basis, but are placed at the time of packing or pelletized to protect the box or group of boxes on the external edges, which are the most exposed against wear by friction with other tougher materials during transport.

For more specific solutions, it is necessary to provide an assembly system that integrates the two kinds of cardboard, namely, sheets of corrugated cardboard and laminated cardboard angle profiles or corner pieces, both elements complement each other to form three-dimensional structures that take full advantage of the advantages of each of the types of cardboard.

Corrugated cardboard has a large load capacity on the edge in the axial direction of the flute, little strength in the direction perpendicular to it and also little strength across the sheet, said element is used as an element to support compression considering the axial direction of the flute. Equivalent in the field of construction with a wall of load, the corner pieces would be the girders, beams, chains, and castles of reinforced concrete.

As a complement to form a stable and strength structure that supports heavy loads, not used for cardboard constructed elements state-of the art defines a wide range of extruded laminated cardboard, with the characteristic of having high strength to axial loads as well as perpendicular loads. This laminated cardboard, is manufactured by means of the splice with adhesive from a plurality of sheets of paper, stacked one above the other. These elements or profiles are used as structural support elements in the vertical, horizontal or oblique position. It is necessary to also provide additional strength to the corrugated board based on the teaching of the strength of laminated cardboard, so splices of sheets of corrugated cardboard used as core of additional support to the inherent strength to the corrugated flute are made at the same time.

The state of the art is defined by a series of documents that describe some laminated corrugated cardboard, furniture elements and structural, such as arrays:

The United States of America Patent Application US2011/011312, published Jan. 20, 2011, corresponding with the international application WO2010024656 and the Mexican Application MX/a/2008/010916, by Luis Felipe Rego Garcia de Alba, describes a structure packaging and display consisting of a hollow cubic body formed with corner pieces on the edges, a plurality of formed with corner pieces shelves which are flat panels where are finally placed in display products.

The Design Application MX/f/2010/000768, filed on Mar. 23, 2010, by Luis Albarrán Torres and collaborators, describes a structure self-supported with two load side walls made of corrugated cardboard United by a plurality of laminated cardboard sills in the form of angle or corner pieces, the structure is an item of furniture such as a desk.

MX 32048 design, granted on 14 Oct. 2010, by Luis Albarrán Torres and collaborators, describes a structure free supporting with two load side walls made of corrugated cardboard joined by a plurality of laminated cardboard sills as angle or corner pieces, this structure is an item of furniture such as a chair.

The International Patent Application WO2010112627, published on Oct. 7, 2010, by Raúl Santiago Martín, describes an assembly of sheets of corrugated cardboard to form a laminated panel where the flutes of each layer overlap in an arrangement where the direction of the flute on each sheet is perpendicular to the previous and next, in order to provide strength in both directions and the panel can be used as support element in both directions flute.

The United States of America Patent Application US2010/0187626, published on Jul. 29, 2010, corresponding with the Mexican Patent Application MX/a/2007/002322, by Luis Felipe Rego Garcia de Alba, describes a structure of packaging manufactured with corner pieces elements (corner pieces) of laminated cardboard, which has the shape of a cube, and corner pieces are placed as edges of the cube, the structural elements are attached at the corner pieces by means of rivets, contains diagonal elements in the faces as reinforcements. The base is a platform with windows to receive items of lifting to move the load.

The United States of America Patent Application US2009/0038989, published on Feb. 12, 2009, by Luis Felipe Rego Garcia de Alba, describes a structure of packaging and display consisting of a body cubic hollow formed with corner pieces on the edges, a plurality of shelves with corner pieces, which are flat panels where finally placed display products.

The Korean Patent Application KR 20090032336, by Lee Gyeong Seok, published on Apr. 1, 2009, describes a chair with backrest type animal's head built with prefabricated corrugated elements, formed with a plurality of punched elements which are assembled by means of slots.

The Mexican Patent Application MX/a/2009/010101 which coincides with the international application WO 2009/027992, by Vinay K. Mehta and collaborators, describes a disposable folding suitcase made of corrugated cardboard, with removable wheels and a handle, consists of two main panels connected by means of side panels which together form the case cover and bottom.

The Japanese Patent Application JP2009005815, published on Jan. 15, 2009, by Tashiro Hideo, describes a flat seat and back chair made of corrugated cardboard that can be assembled manual and quickly, very suitable for use in the event of natural disasters; the legs consist of cardboard folds “Z” shaped with hollow internal elements that form a honeycomb structural in the form of “X”, a back-up with structural support in the form of “Y”.

The Japanese Patent Application JP2009005902, published on Jan. 15, 2009, by Tashiro Hideo, describes a bed frame made of corrugated cardboard, fully foldable, for use in case of disaster. It is consists of a flat cover, a honeycomb shaped with straight flat elements connected in perpendicular directions to form a square grid that supports the flat cover attached to a cover edge to form the drawer or base on which the mattress is placed.

The International Application WO2008096026, published on Aug. 14, 2008, by Francisco Javier López Latorre, describes a means of display objects in the form of chair and built with a sheet of corrugated board with die lines that allow to folding and unfolding to will the display; the flat structure is supported through the use of slots and side tabs; the seat and backrest of the chair is used for print advertising motifs.

The Mexican Utility Model MX1405, corresponding to application PA/u/2004/00274, by Luis Felipe Rego Garcia de Alba, describes an element in packing and packaging, even display made of laminated cardboard corner pieces, using the minimum of material for their manufacture. Angle or corner pieces elements are placed on the edges to form a three-dimensional structure with empty rectangular windows as faces of the structure bounded by corner pieces, these windows perform the function of displaying the products contained within the structure.

The United States of America patent U.S. Pat. No. 5,681,641 which corresponds with the Mexican Patent MX 191683, published on Oct. 28, 1997, by John M. Grigsby and his collaborators describes a structural member consisting of a stack of layers of corrugated cardboard panels attached by adhesive and with a central support element, the most basic unit consists of at least one layer and two corrugated cardboard covers.

The chair of the United States of America patent U.S. Pat. No. 4,648,658, published on Mar. 10, 1987, by Wayne Calco, describes a folding chair in a plane made of a hardened cardboard specification; It consists of base panels that are attached to side panels to form the portion of the base; a panel seat and a backrest that emerges from the back panels.

The United States of America patent U.S. Pat. No. 3,727,979, published on Apr. 17, 1973, by Schier Furtak R., describes a self-supporting structure made of a sheet of cardboard, fully foldable and that deployment is a hollow triangular seat, with three side faces, a cover fold that forms a flat ring with tips on the edges of the faces. The seat is folded in a plane, is completely portable and lightweight.

The International Application WO2007049947 which corresponds with the Mexican Application MX/a/2005/011459, by Luis Felipe Rego Garcia de Alba, describes a structure of packaging manufactured with corner pieces elements (corner pieces) of laminated cardboard, it has the shape of a cube and corner pieces are placed as the cube edges, structural elements are attached at the corner pieces by means of rivets. The base consists of thick elements that form a load platform.

### BRIEF SUMMARY OF THE INVENTION

It is an object of the present invention to provide a system of assembly and structure of laminated cardboard and corrugated cardboard which allows obtain three-dimensional structures very strength and self-supported.

It is also an object of the present invention provide a system of assembly and structure of laminated cardboard and corrugated cardboard, very simple, formed by the adhesion of the ends of the profiles of laminated cardboard in the grooves of the load or support panels or walls made with sheets of corrugated cardboard spliced.

It is still an object of the present invention to provide a system of assembly and structure of laminated cardboard and corrugated board with versatility as formed structures, presenting solutions in the field of furniture, packaging, displays and construction.

It is still an object of the present invention to provide a system for assembly and structure of laminated and corrugated cardboard whose three-dimensional structures are marketed as customs cuts, unassembled packaged to be assembled by the end user that should only apply adhesive to the slots die-cut on the panel of corrugated cardboard, for some cases.

It is an object of the present invention to provide a system of assembly and structure of laminated cardboard and corrugated board, whose custom cut pieces are packed in a custom portable box type briefcase made also in corrugated cardboard.

It is also an object of the present invention provide a system assembly and structure of laminated cardboard and corrugated board, whose 3D structure is assembled easily and without the use of specific tools, only with adhesive and manually by end user.

It is an object of the present invention to provide a system of assembly and structure of laminated cardboard and corrugated board with wrap-around covers of cardboard or smooth cardboard that can be printed with advertising motifs, which form three-dimensional and light weight structures and within the reach of a large number of users.

It is still an object of the present invention to provide a system of assembly and structure of laminated cardboard and corrugated cardboard, with ecological advantages and sustainability that can be manufactured with materials 100% recycled.

It is even an object of the present invention to provide a system of assembly and structure of laminated cardboard and corrugated cardboard with wrap-around cardboard or smooth cardboard covers, where stable three-dimensional structures of furniture are for example: chairs, desks, benches, beds, displays, packaging, and including construction elements of living spaces such as walls and “mezzanines”.

### BRIEF DESCRIPTION OF THE FIGURES

FIG. 1a, shows a perspective view of a splice of corrugated cardboard forming supports, walls or load elements of the present invention.

The FIG. 1b shows the cutting of corrugated cardboard support and the shape of the die-cut slots that receive the ends of the profiles of laminated cardboard, note that the upper and lower elements form the support covers, the outer cover generally does not contain die-cut slots and it serves as a cover to them.

FIG. 2, shows schematically the manufacturing process of the base cells or base elements of corrugated cardboard and laminated cardboard profiles.

FIG. 3 a, shows a piece of cardboard corrugated with slots for the ends of the profiles of laminated cardboard, on the inner side of the support in which is placed an adhesive.

The FIG. 3b shows a piece of corrugated cardboard with the ends of the profiles of laminated cardboard into the slots on the inside of the support, the assembly shows a semi-finished three-dimensional structure.

FIG. 3c, shows the piece of corrugated cardboard with the ends of the profiles of laminated cardboard into the slots on the inside of the support, at this stage the support in FIG. 3a and the semi-structure in the FIG. 3b, combine to form a finished structure or bank for this embodiment of the invention.

FIG. 3d, shows a three-dimensional structure formed by means of the system of the present invention, a preferred embodiment is a bench to sit, durable and lightweight.

FIG. 4a, shows a piece of cardboard corrugated with ends of laminated cardboard profiles targeting the slots where previously an adhesive is placed.

FIG. 4 b, shows a piece of cardboard corrugated with slots occupied by the ends of the pieces of laminated cardboard (crossbars) normal to the support, another piece of support slots previously with adhesive is superimposed to the ends of the crossbars of the semi-finished structure.

FIG. 4c, shows a three-dimensional structure formed by means of the system of the present invention, a preferred embodiment is a chair to sit tough and lightweight, and made of recyclable materials.

FIG. 5a, shows a structure of corrugated and laminated cardboard exploded, where the component elements are pointing to the position of use; the crossbars towards the internal slots of the side supporting elements, and the slots of the intermediate fastening elements.

The FIG. 5b shows a three-dimensional structure formed by means of the system of the present invention, a preferred embodiment is a bench to sit tough and lightweight.

The FIG. 6a shows a structure of corrugated and laminated cardboard exploded, where component elements are pointing to the position of use; the crossbars towards the internal slots of the side supporting elements.

The FIG. 6b shows a three-dimensional structure formed by means of the system of the present invention, a preferred embodiment is a desk cover that is complemented with a glass cover.

FIG. 7a, shows a first piece of side support made of corrugated cardboard, the outer cover made of cardboard wraps the inner piece to not to allow the entrance of moisture to it, the inner part has slots where the ends of the profiles are housed in laminated cardboard.

The FIG. 7b, shows a piece of intermediate support made of corrugated cardboard, the inner part has slots where profiles or crossbars are housed in laminated cardboard.

The FIG. 7c shows a second piece of side support made of corrugated cardboard, the outer cover made of cardboard wraps inner piece to not to allow the entrance of moisture to it, the inner part has slots where the ends of the profiles are housed in laminated cardboard.

FIG. 8a shows the direction of assembly of the first piece of side support with intermediate support made of corrugated cardboard with the external cover envelope covering the whole of the inner part, the folds tabs are located on the inside of the support pieces, the ends of the profiles in laminated cardboard are directed to be accommodated into the corresponding slots.

FIG. 8b, shows the assembly of the first, second lateral and medial parts of the supports, as well as assembly of the lower cross supports, the ends of the profiles in laminated to be accommodated into the corresponding slots cardboard. Both supports are cover slots where it is hosted or inserted a longitudinal section from each of the crossbars.

FIG. 9a, shows assembly of cover cross supports, into the corresponding slots where it has previously poured adhesive.

The FIG. 9b shows the base of assembled bed as a whole, the three lower supports, upper and lower crossbars forming a flat surface on which is placed the mattress.

FIG. 10 a shows the wrap-around outside cover in cardboard in a display shelf.

The FIG. 10b shows the central wall or core support made of layers of corrugated board with die lines and slots that contain tabs; this wall forms a display shelf.

FIG. 10 c shows the cutting of the support crossbars of the shelves, these supports made of laminated cardboard or corner pieces sections, also shows the tray in corrugated cardboard forming a shelf display shelf.

The FIG. 10d shows the placement of wrap-around outer covers on the central wall of support, specifically on the inner and outer faces of the side sections of the central wall.

The FIG. 10e shows the placement of trays shelves, prior to the closure of one of the wrap-around side covers, which is closed until the final step.

FIG. 11a, shows a perspective view of the placement of the support crossbars of the shelves, prior to the closing of the wrap-around side cover.

The FIG. 11b shows a view in perspective of the closing of wrap-around side cover, and also the tabs of the shelves that provide structural strength.

FIG. 11 c, shows another perspective view in perspective of the closing the wrap-around side cover, an also shows the area of the shelves where display products are placed.

### DETAILED DESCRIPTION OF THE INVENTION

The corrugated cardboard is one of the main raw materials for the manufacture of boxes, packaging, containers, taking part in most of the chains of production and distribution worldwide. In its basic form consists of a first layer of smooth paper or liner, a second layer of corrugated paper (corrugated, fluted or medium) and a third layer of smooth paper, bonded through an adhesive so that the three layers to behave as a single structural element. The corrugated cardboard has a high strength to compression in the axial direction of the channels defined by the curls or flutes. Depending on the height between peak and valley of them is that it defines the type of flute. A-flute=5 mm, B-flute=3 mm, C-flute=4 mm, E-flute=1.5 mm. For the purpose to further increase the strength mentioned are manufactured double or triple corrugated forms in which are sandwiched smooth and wavy papers, which are defined according to the corrugated splice, for example: a double corrugated BC has a thickness of 7.00 mm, i.e. the sum of a B-flute and a C-flute. The corrugated cardboard is manufactured in sheets of different sizes to then transform them through adhesives and die machines in boxes, packaging, displays, etc.

The smooth paper works as cover of the wavy layer (flute), forming a structure with mechanical strength increased to loads in the axial direction of the channels defined by the curls or flutes, i.e., increased strength to compression, so is possible to stack several boxes filled of product without these deforming considerably. Strength is given by such factors as the weight or strength of the papers and the height of the wave or flute.

Laminated cardboard is manufactured by joining several layers smooth paper with a waterproof adhesive (VCT) to make it useful in the manufacture of items subject to humid conditions and requiring increased strength expressed in g/m², typical strengths are handled between 600 to 1250 g/m². Unlike the corrugated cardboard, it is manufactured only using smooth paper by joining multiple layers with same adhesive.

To make a laminated cardboard 150 (in mils) caliber will join five papers of 30 mils.

Laminate cardboard comes in various presentations as extended sheets of one lesser caliber, narrow sheets or slabs of high caliber, narrow sheets with longitudinal folds at right angles forming corner pieces and rectangular channels “U”, sheets attached radially forming tubes. Laminate cardboard is much heavier than the corrugated cardboard, but therefore has an excellent capacity of axial and transverse load, suitable for use as structural elements of load.

The die-cutting process consists in marking or cutting a material using pressure with a tooling called die. In the context of the present application, stamping is performed by means of a wooden board with grooves in the form of the desired shape in which are inserted sheets that follow the contours of the figure, through a die machine the corrugated is located between the knives and a plate, by exercising pressure alleged figure is cut.

The process to adhere one surface with another by means of glue is called the splice, can be done manually or by means of a suitable machine. A surface as the cover or the corrugated surface is covered with adhesive and prepared to overlap another sheet of corrugated cardboard or simply a sheet of cardboard white or printed with advertising or informational motifs.

Through the splice process to a single or double corrugated cardboard, more layers of corrugated cardboard, are added in order to increase its thickness, strength and load capacity. It is possible to splice blank sheets or parts already die-cut. Additionally it is possible to splice multiple parts with the direction of the parallel flute between all of them. It is also possible splice intercalated transverse flutes one by one, for example, the pair parts in direction of 90° in relation to the odd. With the splice of flutes in the parallel direction is achieved a support element with a compressive strength increased in the longitudinal direction of the flute; but relatively weak in the transverse direction, the interleaving of flute directions forms panels with the same load capacity in both directions.

This application basically consists of the manufacture of several panels of corrugated cardboard formed through the splice of sheets of cardboard corrugated die-cut from a specific shape preset according to the intended structure. The splice is formed with the splice of several layers of corrugated board with slots and last layer without slots that functions as a cover. This so that once formed panels, they are inserted in sections of profiles of laminated cardboard into the die-cut slots to obtain a volumetric element, the last layer or cover makes the function of cover on the end of the profile entered into the slot or die-cut prior to placement of adhesive into the slot to achieve a stable three-dimensional structure. It is possible to make variations of form at will of the user as for example, silhouettes in traditional forms such as chairs or abstract forms. Covers and profiles have natural color, painting, or prints.

Laminated cardboard profiles have several forms which are adapted according to the needs of the structure, for example, corner piece, “U” channel and the tube. The quantity and caliber of the profiles are adjusted according to the requirements of design and load into support or load panels made of corrugated cardboard, the panels can be equal, mirror panels, of different sizes and shapes, parallel or oblique, divergent and convergent, perpendicular to the floor, parallel to the floor, as top cover, side cover and supports intermediate, etc.

The corrugated cardboard spliced forming support panels and therefore the support elements of various structures object of the present invention, must contain a plurality of slots in the form and location set to form the desired three-dimensional structure, elongated laminated cardboard profiles are placed in these slots by pressure and fully defined by the inner layer of smooth paper a base format used as panel covers are used for external support parts. Support internal panels are included in some types of structures that do not require such covers, in this case, slots are interns from side to side, i.e. they are slots preset defined by the shape of profiles of laminated cardboard used to form three-dimensional structure. The covers have the function of prevent profiles through the slots completely and get out of the body of the panel, the last layer or outer layer of corrugated cardboard base format has the same shape as the first one; but not to be die-cut slots on it, in this way profile covers when it reach that last layer which operates as a cover and is kept in an internal location within the support.

Elongated profiles are maintained within the slots with the application of an adhesive inside each and then is inserted the end of laminated cardboard, providing also a suitable drying time according to the adhesive, which in preferred embodiments is white glue.

The manufacturing of all structures with this application process is similar in all the structures obtained by the assembly system, namely, is placed on a flat horizontal surface a support panel manufactured with a plurality of base formats and with the respective slots facing up or presenting the plurality of them of front assembly operator; then is poured glue inside each die-cut slots that of said support panel; then started to place under manual pressure and properly aligned each laminated cardboard profiles, preferred embodiments of laminated cardboard profiles should take a position to make an angle relative to the horizontal plane or the inside of the support panel, manual pressure to ensure that the end comes to cover and runs through the entire depth of the groove marked by die is exercised; immediately is placed another back mirror panel with the slots facing toward the front of the operator, in each of the slots is placed adhesive to insert therein the free ends of the profiles of the piece previously formed, placing the ends of the profiles in each slot, is exerted pressure to cover these ends and thus is formed the three-dimensional structure built with base assembly system and structuring object of the present invention. In a preferred embodiment of stable self-supported the position of the profiles they form a right angle with respect to the panels of corrugated cardboard; but for aesthetic reasons or design there are other forms of three-dimensional structure of back panels that form oblique angles themselves or from the profiles of laminated cardboard; Yet, the position of laminated cardboard profiles form oblique angles with respect to themselves.

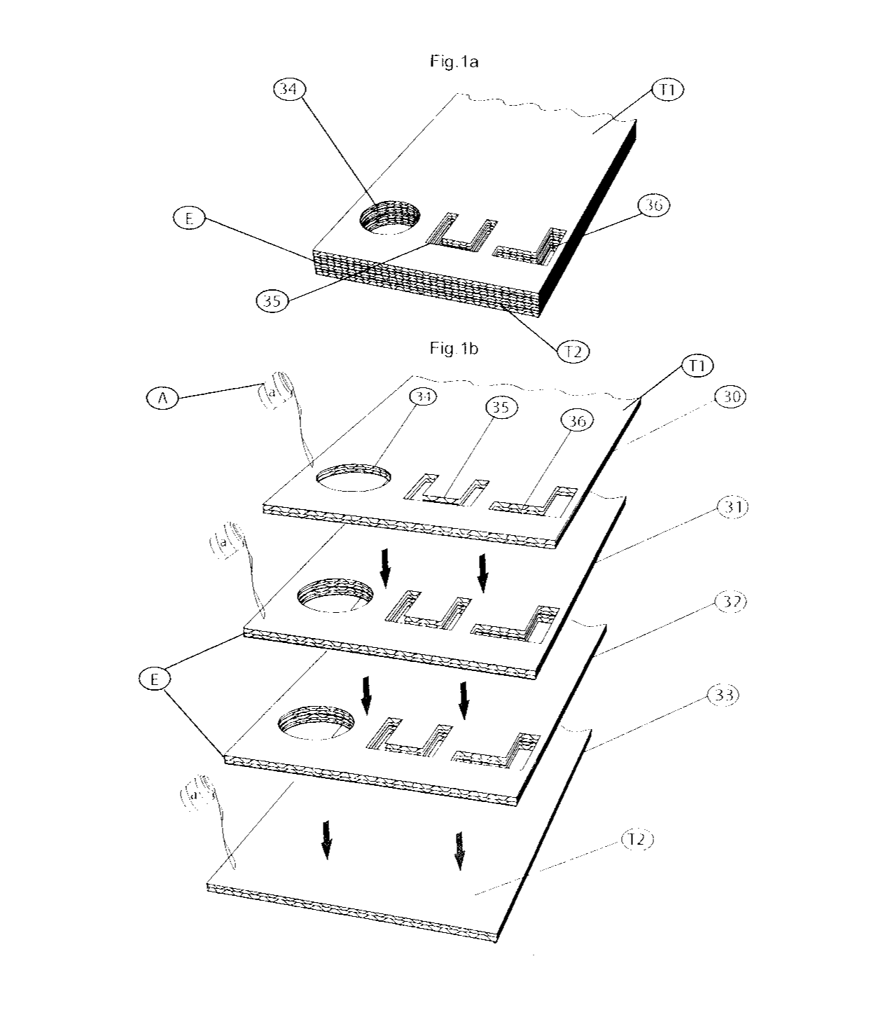

The novelty of the assembly system it will be understood more clearly with the help of figures, for example FIG. 1a, which presents a view in perspective of a splice of base formats forming the support of the present invention, the splice panel (E) consisting in this case particularly illustrative of a plurality of layers base formats of corrugated board with the flute aligned in the same direction to form an intermediate or central support panel which is associated with a layer of corrugated side (T1 and T2) which makes the cover function and support of the first splice, the splice of the invention is die-cut with slots that are housed inside laminated cardboard profiles; one of the covers can be die-cut and present the same holes that splice; but the other does not, so it meets specifically the cover function and hold the end of the profile of laminated cardboard immersed into the slots on the support or splice panel (E). In an embodiment the die-cut slots shapes are round (34), angular “U” (35) and angular “L” (36).

The FIG. 1b, it is a perspective view of the arrangement of FIG. 1a, which defines some splice layers (E) with three layers of corrugated cardboard (31, 32) which form the intermediate or central splice and the covers in one of the preferred embodiments, the die-cut covers (T1) with the slots (36) in the form of “L”, “U” shaped slot (35) with rectangular angles, slot (34) of round shape, this cover also shows clearly the direction of the ripple of flute (30) on the cover which provides increased strength of corrugated sheets, is notorious that the direction of the flute has the same orientation in the splice and covers. In FIG. 1b (T1) cover has slots to allow the passage of the profile of laminated cardboard towards the splice support (E), the cover (T2) has no slots since it works as a cover the ends of laminated cardboard profiles that form the final structure; but the same longitudinal direction of the flute (33) which must coincide with the splice is defined. Joint (E) intermediate or corrugated cardboard, covers (T1 yT2) also of corrugated cardboard form a laminate that provides strength of support at the three-dimensional structure of the present invention in its different embodiments, splice is carried out through the application of adhesive (A) in each of the intermediate layers.

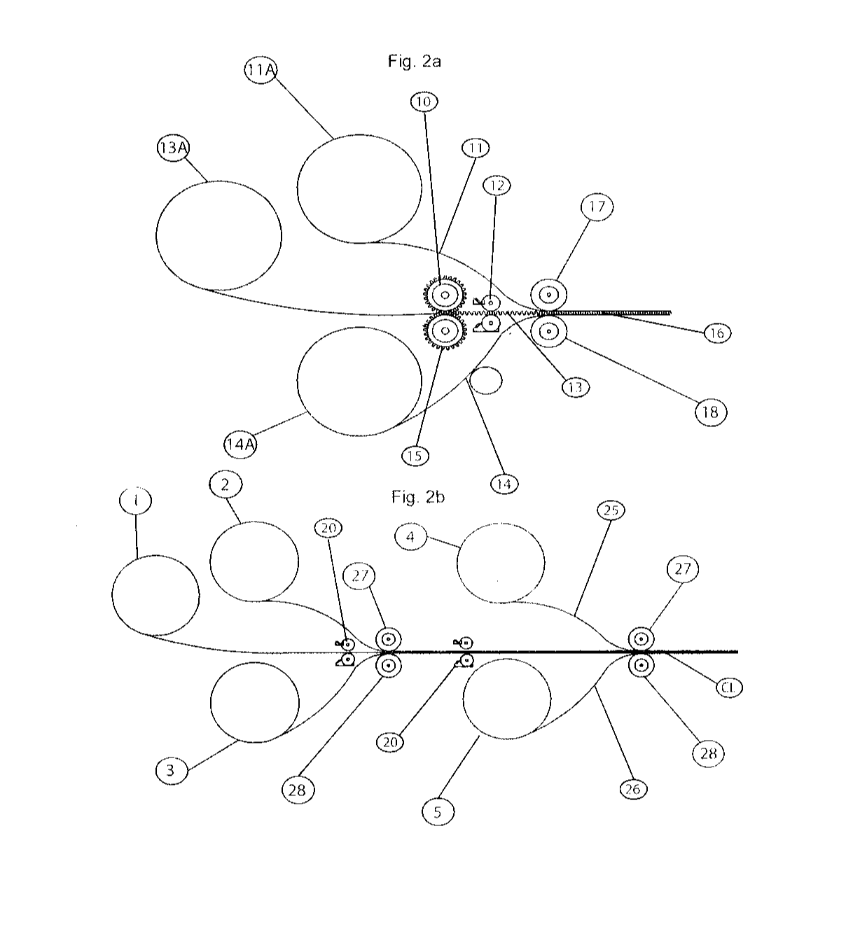

FIG. 2 shows a view that defines the process of manufacturing of corrugated cardboard (16) and laminated cardboard (CL) that he possesses superior strength, it consists of a coil of smooth paper (13a) that passes through a station of toothed rollers that give the corrugated shape; applies adhesive to corrugated shape ridges at the station (12); application of a top layer and a smooth paper from two spools lower leader (11 and 14) which are the sheet top cover (11) and the sheet bottom cover (14), the assembly passes through rollers station (17 and 18) which will apply pressure and heat to cure adhesive, thus is formed base formats of corrugated cardboard (16). The process of laminated cardboard is similar, except that the number of layers is greater and the toothed rollers are removed. Namely, the embodiment where it have five reels leader, coil (1) provides a first sheet of smooth paper which applies adhesive in the station (20), then two other coils leader (2 and 3) provide other two layers of smooth paper over the first layer adhesive, coating of three passes to a curing station by pressure and heat (27 and 28); on the resulting splice adhesive is applied in another station (20); other two coils (4 y 5) have other two layers of smooth paper that cure by heat and pressure in the rollers station (27 and 28), in this way is produced laminated cardboard (CL), which is forged by pressure to obtain the desired shape of the profile.

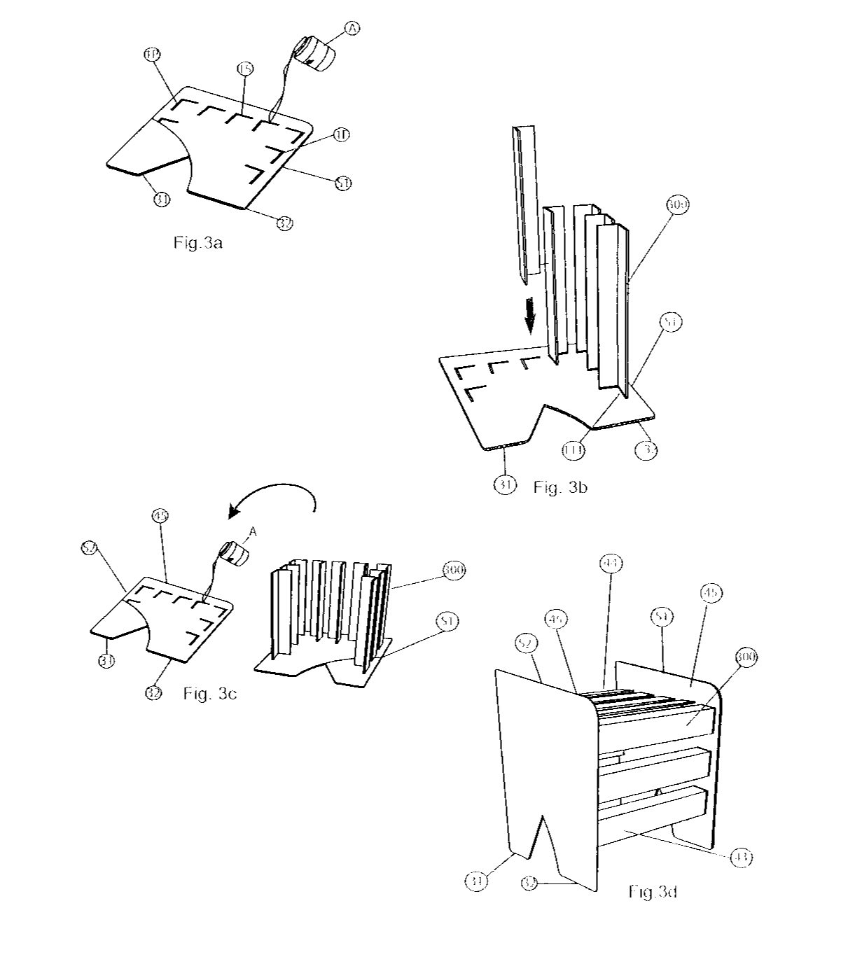

FIG. 3a, shows a view in perspective of the process of assembly of one of the structures of the present invention, namely the first step which adds adhesive (A) or white glue inside the set of slots (1f) of the front section, (1s) in the upper section of the seat and (1p) of the rear section of the bench, altogether receiving end of profiles of laminated cardboard on the inner side of support (S1) of corrugated board formed in advance and having lower edges (31 and 32) of support with the floor which are protected with an insert of a sheet of most hard and strength material in comparison with the corrugated cardboard, such as sheet metal or plastic attached to the edge by means of an adhesive. To make the operation of applying adhesive is placed lamination of corrugated cardboard (S1) on a flat surface or floor with slots faced to the applicator for adhesive, slots (1f, 1s and 1p) arranged in aligned sets in the horizontal direction and the vertical direction; the horizontal arrangement forms a upper plane and two vertical arrangements form each a vertical plane of reinforcement, glue on each of the nine slots is poured so that then put the profile of laminated cardboard forming described plans.

The FIG. 3b, is a perspective view showing the assembly of the perpendicular profiles (300) in relation to the support (S1) provided with corresponding slots on one side, in these slots previously has poured adhesive so quickly staying profiles (300) ends that are placed manually in the direction indicated generating the union (111) between support (S1) and die (300), the support has edges (31 and 31) that come in contact with the supporting surface or floor when the structure is completely assembled.

FIG. 3c, presents a perspective to one of the embodiments of the structure of the present invention, in the case of a bench, two side support (S1 and S2) laminates fastened by ends to profiles (300) laminated cardboard, supports have an upper edge (45) and two bottom two edges (31 and 32), the plurality of profiles (300) immersed in the corresponding slots in the side laminated to a perpendicular relationship on which is over the other (S2) support matching the ends of the profiles with the corresponding slots in the support.

FIG. 3d, shows a perspective view of one of the embodiments of the structure of the present invention, in this case it is a bench; the laminated (S2) fitted with the edge of lower support (31 and 32), an upper edges (45), slots not shown in which slots is inserted one end of (300) profiles laminated cardboard, to form a upper surface of seat (44), a frontal zone (43) of strengthening, in this embodiment these profiles has a shape of “L” or corner pieces in dimensions of 3 in by 3 in (7.62 cm×7.62 cm) and 3 in by 2 in (7.62). (cm×5.08 cm), i.e., is a slab of laminated cardboard die-cut at a right angle. The five profiles (300) of the horizontal arrangement form the upper surface support of the seat (44), the end upper profiles along with the profiles in the vertical direction are each a reinforcement rear and frontal plane.

The sequence of FIGS. 3a-3d show is the manufacture of a bench or seat as implementation of the basic system of assembly and structure of this application, begins forming a panel with four silhouettes of die-cut cardboard corrugated, three of them have been died-cut with slots and one without such slots. By means of adhesive stick four sheets of corrugated, thus forming the first panel, repeats the operation to obtain a second mirror panel the, then is poured glue in the slots and then are inserted the corner pieces panels in each slot allowing the glue or adhesive dry. Poured glue into the slots of the second panel, the previously assembled structure is taken and placed on the second panel with corner pieces ends faced downwards and in the direction of the groove, is exerted pressure on the assembly until the ends of the corner pieces panels reach stop formed by the cover of the second panel, prior to let dry the adhesive on the last step, ensure the perpendicularity of the corner pieces on support panels. In a preferred embodiment of support panels cover is larger than the die-cut layers, with side tabs that can be folded in order to hide the flute of the corrugated forming it, this last layer or cover can be smooth cardboard, white cardboard or even printing.

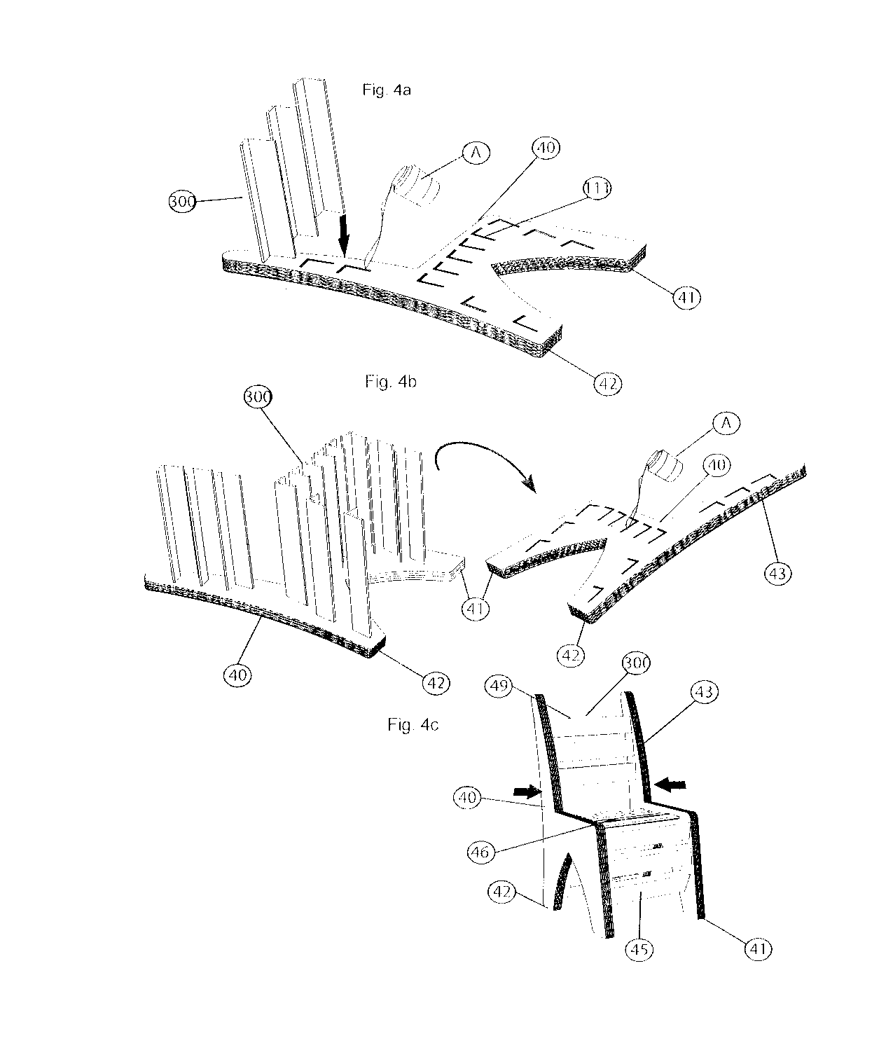

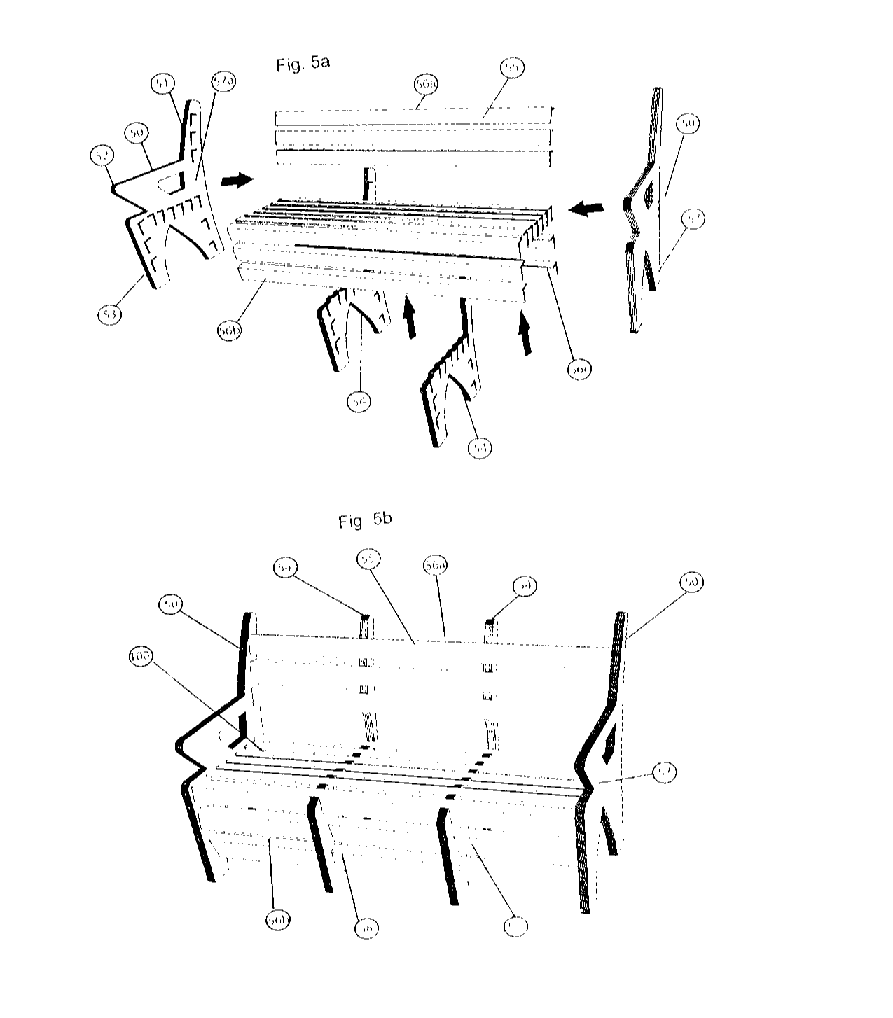

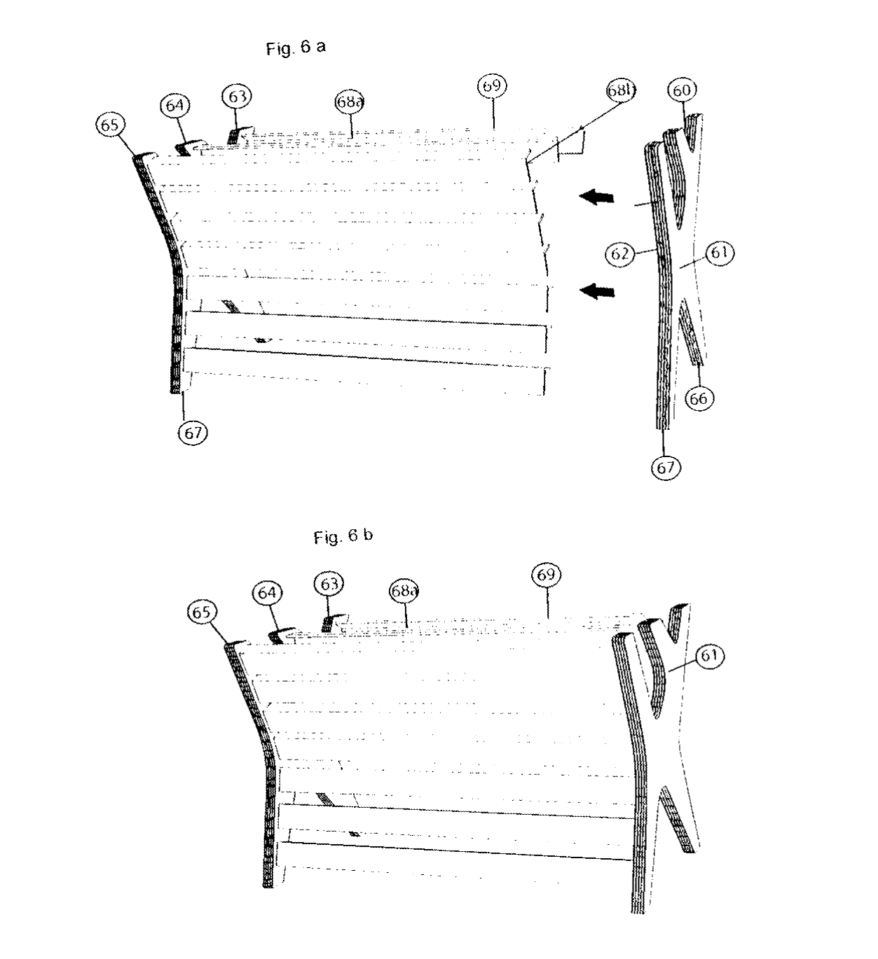

FIG. 4a, shows the inside support (40) of corrugated cardboard with the slots (111) where are placed the ends of the profiles (300) after application of the adhesive (A) to form the complete structure resulting in a chair; Support (40) in addition to the arrangement of slots that form together with profiles of support areas, seat and front and rear reinforcement, has upper sections (43) which cooperate to hold the three profiles that form the back of the chair; the support sections with floor (41 and 42), frontal section (41) which also helps the front support of the profiles; the rear section (42) which similarly is involved with the rear support of the profiles. In each of the slots (111) spilling adhesive (A) so that contact with the ends of the profiles they adhere to support formed with corrugated cardboard.

FIG. 4 (b), shows a perspective of one of the forms of the structure of the present invention, the particular case of a chair made of corrugated cardboard and laminated, consists of two side supports of corrugated cardboard (40) in whose internal face has a series of grooves die-cut with the shape adapted to the profile of laminated cardboard (300) forming the seat, back, front and rear fastening devices; the side supports on corrugated cardboard (40) possess two surfaces (41 and 42) with floor and an upper section thinned (43). Profiles of laminated cardboard (300) are placed individually in each of the slots on the inside of the side support to form a chair semi-finished section that is completed with location of other mirror support of corrugated cardboard in the ends of the profiles of laminated cardboard already placed perpendicular to the plane of the support (40) previous preparation with adhesive (A).

The FIG. 4c, shows the complete structure formed with two supports (40) of corrugated cardboard and a plurality of profiles (300) “L”-shaped laminated cardboard forming sections of support (44), seat (46) and front reinforcement (45); each side support with (41 and 42) lower ends of support with floor and a upper end (43). Shapes and sizes of laminated cardboard profiles preferential are “L” shaped squarely with dimensions of 3×3 or 3 in×2 in (7.62 cm×7.62 cm and 7.62 cm×5.08 cm). Support formed by three, the seat by six profiles (300), and each of the front and back reinforcements with a pair of profiles.

In a preferred embodiment the support panels cover is larger than the die-cut layers, with side tabs that can be folded in order to hide the flute of the corrugated forming it, this last layer or cover can be smooth, white cardboard or even printing.

FIG. 5a, is a cutting perspective of one of the preferred structure of the invention, in the case of a bench seat, consists of two side supports (50) of corrugated cardboard and two intermediate supports (54) of the same material, the side supports (50) have a plurality of grooves on the inner faces that housed inside the ends of edges (55) in the form of “L” made of laminated cardboard; intermediate supports (54) have through slots (58 and 59) at the front edge that allow to pass through the same fastening profiles (55), at the upper edge of the backrest and seat has inbound slots that host only one edge of the transverse profiles. The section of the backrest (56a) has three slots that accommodate the same number of profiles to form the backrest in co-operation with the upper sections (51 and 54) of the lateral and medial supports, seat section consists of seven slots that accommodate the same number of profiles, where the seventh corresponding to the transition zone between the seat and the front reinforcement, said profile is placed faced in relation to the other to provide comfort in the legs of the user of bench and to also work with the front reinforcement; the front reinforcement (56b) consists of two slots that accommodate the same number of profiles (55), the rear reinforcement (56 c) also consists of a pair of slots that accommodate the same number of profiles (55) of laminated cardboard; profiles of front and rear reinforcements passing through slots in the intermediate supports and its ends are housed into the slots on the inner faces of the side support of corrugated cardboard, upon application of the respective adhesive. Profiles that form the backrest and seat, ends are housed in the corresponding slots in the inner faces of the side supports (50); but in the case of intermediate supports (54) only a section of the profile is hosted on the slot of a transversely to the edge of the body of the support, i.e. the profiles are crocheted into the slots. The bench is formed with two side supports (50) and two intermediate supports (54) in cooperation with a plurality of profiles (55) at number fourteen situated transversely forming one of the preferred embodiments of the present invention and is a bench to sit. Intermediate (54) and side (50) supports have a vertical front edge (53), only the side support have a section of horizontal upper edge (52), which makes the function of arm rest; the same side supports formed with a splice of corrugated cardboard in which a section is die-cuts with slots to accommodate the end of profiles, possesses an external cover (57) of corrugated cardboard which avoids the lateral shift of profiles and an inner cover (57a) with the plurality of slots that guide the ends of the profiles.

The FIG. 5b, it is a perspective view of the structure of bench fully assembled, presenting their backing (56 in) sections consisting of three types (55), seat (100) formed by seven profiles (55) and (56 b) front reinforcement formed by means of an arrangement of two laminated cardboard profiles (55) that pass through slots through (58 and 59), side supports (50) with outer covers (57) and intermediate supports (54). Shapes and sizes of laminated cardboard profiles preferential are “L” shaped squarely with dimensions of 3×3 or 3 in×2 in (7.62 cm×7.62 cm and 7.62 cm×5.08 cm); another preferred embodiment of profiles has a “U” shape inverted and elliptical or circular section.

FIG. 5a, shows another goodness of the assembly and structuring system to incorporate intermediate panels as structural reinforcement elements. Unlike the external panels, slots through the panel in order to allow the corner piece or profile to pass through the same downloading the load into the slots to increase the load capacity of the structure in the area of seat and backrest is designed in such a way that the silhouette matches the corner pieces to avoid hassles by edges the user since the outline remains tangential to the surface of the corner pieces, Additionally the external panels have an armrest that increases comfort.

In a preferred embodiment of support panels cover is larger than the layers die-cut, with side tabs that can be folded in order to hide the flute of the corrugated forming it, this last layer or cover can be smooth cardboard, white cardboard and even with printing, this feature is most appropriate for the external panels.

FIG. 6a is a perspective exploded view from one of the preferred structure and presenting in this case a desk with upper glass support deck, consists of two side supports (60) made of corrugated cardboard and a plurality of horizontal profiles laminated cardboard that keep the structure stable for assembly (69) and serve as desk cover. Namely side vertical supports (60) consist of an assembly of several layers of base format by means of an adhesive which together form a support panel with external cover (61), the side supports (60) have a similar form to the “X” with three upper (63, 64 and 65) and two bottom (66 and 67) ends supported with floor, side supports (60) have an inner cover (62) with slots in each of the cover ends and along one of the edges of the “X” to put inside them to the ends of profiles (69) of laminated cardboard forming three sections, namely a horizontal cover (68), a positive tilt (68 b) and another with negative tilt (68c), section (68) is the upper horizontal base on which is placed a hard cover as the desk cover work area preferably of glass, tilt sections (68b and 68c) form the structure that gives stability to the entire assembly, which takes place in the same manner as all preferred structures of the invention together with the side supports (60) by placing panel with slots in front of operator, pouring out adhesive on each of these slots, insert one end of each of the profiles of laminated cardboard and put pressure on them, pouring adhesive on each one of the slots on the other side support and join with the ends of profiles already placed on the other support. Note that profiles are in a perpendicular position to the first support and that the second support only overlaps with the ends of the profiles into the corresponding slots.

FIG. 6b shows a perspective of the already assembled structure and form the desk cover as one of the embodiments of this application, the side vertical supports (60) with external cover (61) hold on its inner face a plurality of laminated cardboard (69) and specifically rectangular “L” profiles, the three upper profiles and placed each one in the upper ends (63, 64 and 65) of the side support to form the horizontal section (a 68), where the profiles of the ends are placed with the concave side facing each other; then three profiles in a descending arrangement with positive tilt and three with negative tilt to form a stabilizer vertical structure of that turns out to be the front face of the desk cover; altogether to form the desk required two side supports (60) and nine profiles laminated cardboard (69) assembled as described in this same paragraph corresponding with the figure.

The system applies with horizontal panels to the floor, also the incorporation of other materials and positioning of divergent corner pieces. In the case of the desk of FIG. 6, adds additional material other than cardboard, specifically a cover glass, MDF, HDF, wood, melanin, Formica, plastic, etc. In addition to protect structures from the hard floor surface abrasion they are used to protect the lower edge of the support panel and in contact with the floor, these elements are heels of hard material. Corner pieces lose parallelism and are positioned in a divergent manner by formal and functional issues to counteract divergent efforts that undergo the structure.

The “C” panel, is suitable for any solution that requires access to the area of the furniture on one side only, to be three structural sides with a “C” shaped panel allows us greater rigidity of the structure in such a way that for some cases it is not necessary to use glue to secure the laminated cardboard profiles on panels. The elimination of the use of the glue in the final assembly produces savings of time and material, but better yet, makes the structure which can be dismantled and allows the construction of shelves or separable displays.

The following structure or preferred embodiment of the invention is a bed or bottom of it made crossbars of laminated cardboard and corrugated cardboard supports, supports consist of a wrap-around cover cardboard wrapping a central splice which provides support, bed consists of two side supports, right and left, a central support and a plurality of laminated cardboard profiles of 2 in×3 in (5.08 cm×7.62 cm) in amount of 15 and up to 25 parts.

The method of assembly has the steps described below:

Place a side parallel to the center support and place corner pieces or profiles in the corresponding slots that have previously been puffs in them, then proceeds to insert the ends of the profiles in the corresponding slots in the inner side of the other side support, placement of profiles is prior to placement of adhesive on each of the slots. Once it is finished insert all profiles, it is left to dry the adhesive and is pressuring the external faces of the side supports so that the ends of the profiles come in contact with the inner surface of the covers.

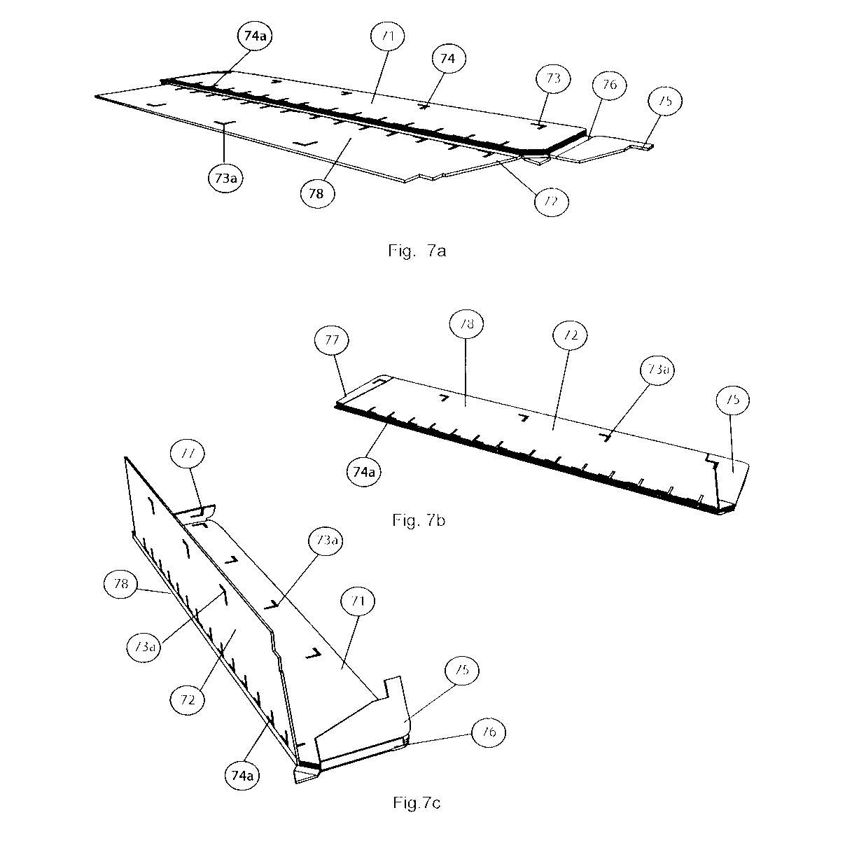

FIG. 7a shows the cutting of a side support, which shows the side support (71) made with a splice of corrugated cardboard that have through slots (73) and edge slots or sets (74), both accommodate perpendicular profiles made of laminated cardboard. Support or central body of load (71) is placed on a wrap-around cover (78) made of cardboard and die-cut with slots (73 and 74), security tabs (75), cover is attached to the support by means of adhesive, support protects moisture in addition to providing increased workloads or to compression and bending strength. The cover consists of two longitudinal sections (72 and 76) that cover the body of the support (71) when both of them fold over themselves to form the side support of the structure in the form of the present invention bed.

FIG. 7 b, shows central support (72) wrap-around the cover (78) with safety tabs (75 and 77) attached and bent to provide security support to the center support, matched the slots (73 a, 74 a) that host to the crossbars or profiles of laminated cardboard.

FIG. 7c shows the side support exploded, which shows the side support (71) made with a splice of corrugated cardboard that have through slots (73) and edge slots or sets not displayed, both of them accommodate perpendicular profiles made of laminated cardboard. Support or central body of load (71) is placed inside a wrap-around (78) made of cardboard and die-cut with corresponding slots (73 and 74), safety tabs (75) and (77), cover is attached to the support by means of adhesive, support protects moisture in addition to providing increased workloads or to compression and bending strength. The cover consists of two longitudinal sections (72 and 76) that cover the body of the support (71) when both of them fold over themselves to form the side support of the structure in the form of the present invention bed.

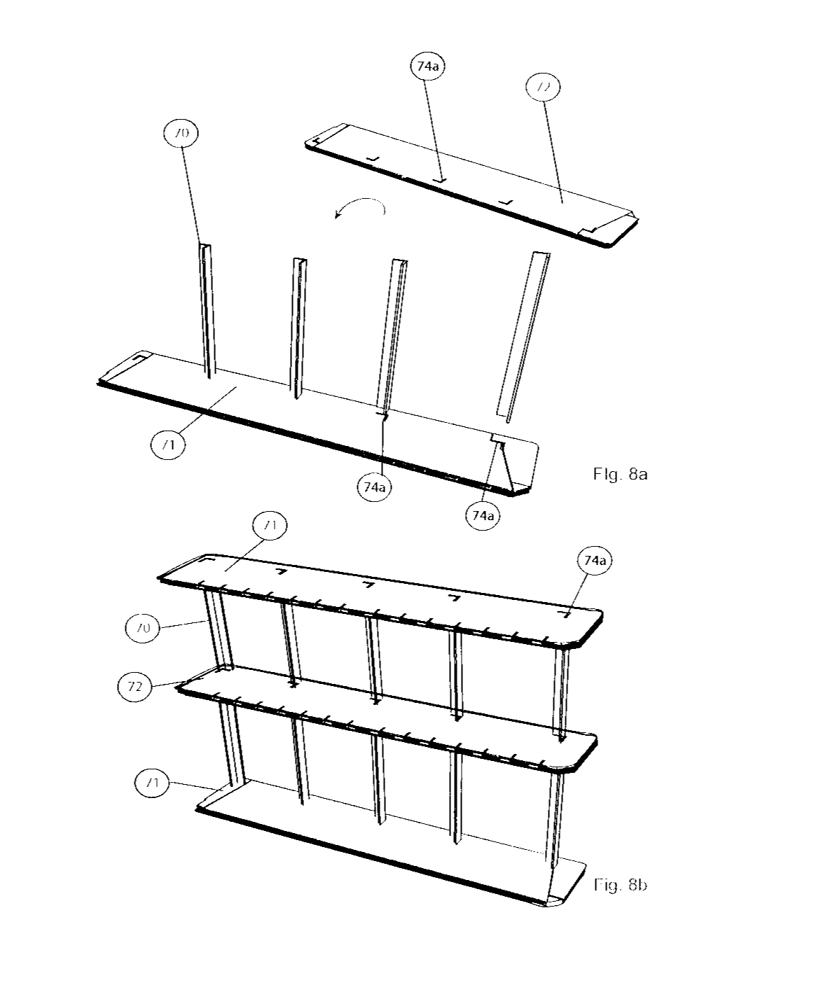

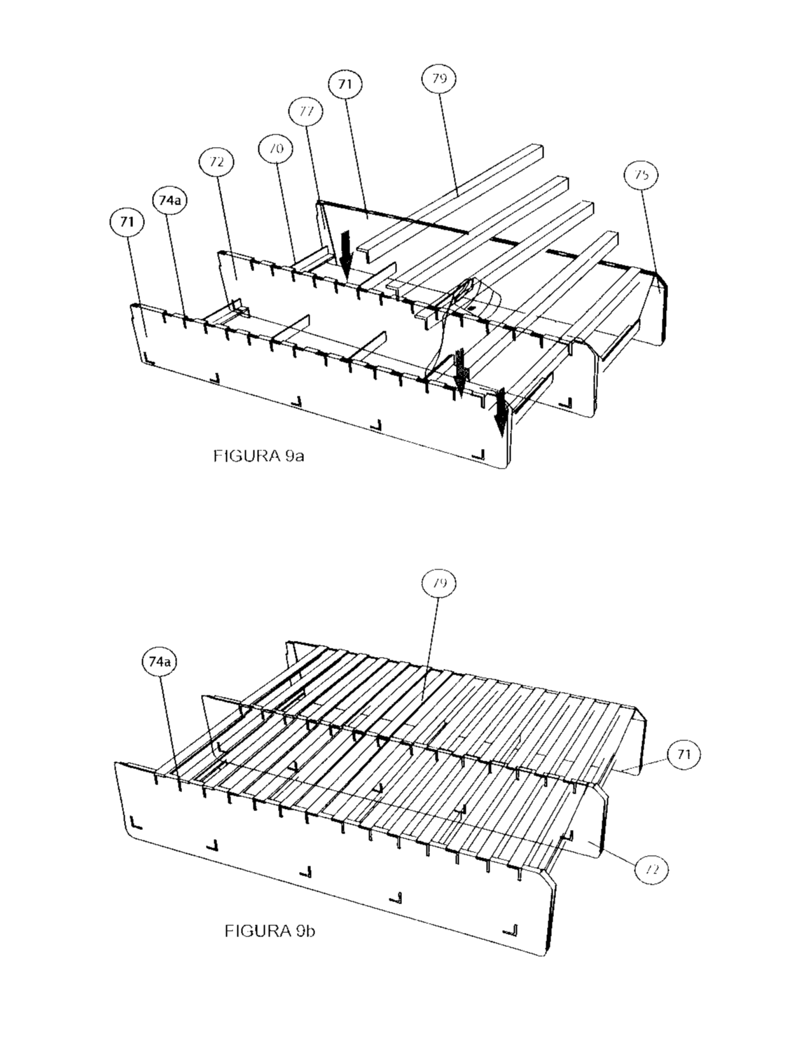

FIG. 8a shows the first step of the structure assembly in form of bed of the present invention, takes any support the lateral side (71) and center support (72) to begin to insert corner pieces or profiles (70) into slots (73a) where has been previously placed adhesive.

FIG. 8b shows the second step of assembly of the structure embodiment of bed of the present invention, takes the other support the lateral side (71) and together with the central support (72) to complete the insertion of the corner pieces or bottom section (70) into slots (a 73) where has been previously placed adhesive.

FIG. 9 shows the third step of the structure assembly in form of bed of the present invention, begin to place the corner pieces or upper profiles (79) crocheted in the upper slots (74a) of lateral sides supports (71) and central support (72) where has been previously placed adhesive. Once placed all crossbars has a surface flat formed by strength structural elements that support the mattress of the bed, which will be light and strength to support loads of more than 200 Kgs.

FIG. 9b shows the entire assembly structure in the present invention bed embodiment, corner pieces or cover profiles (79) set into the upper slots (74a) of supports on the lateral sides (71) and the central support (72) where has been previously placed adhesive. Once placed all crossbars has a surface flat formed by strength structural elements that support the mattress of the bed, which will be light and strength to support loads of more than 200 Kgs.

In a preferred embodiment of support panels cover is larger than the die-cut layers, with side tabs that can be folded in order to hide the flute of the corrugated forming it, this last layer or cover can be smooth, white cardboard or even printing.

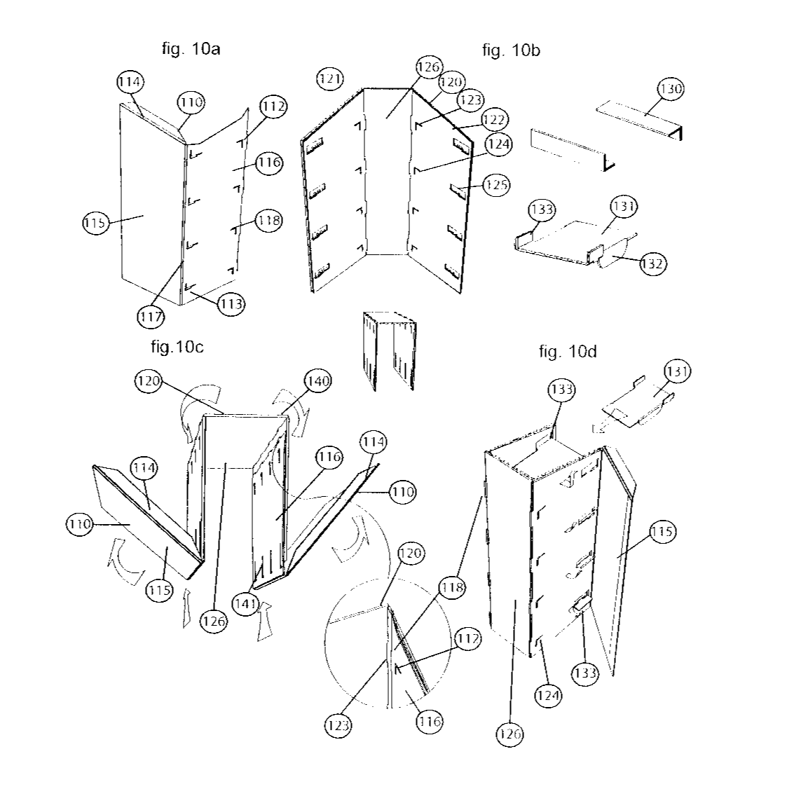

FIGS. 10 a-e show another embodiment of structures that can be obtained with the system of assembly of the present invention, this embodiment is a rectangular body rack display with shelves arranged in descending order, said rack display with increased strength due to its construction with a core or load center made of corrugated board with die-cut and an envelope or two-piece cover made of cardboard which can be laminate, print advertising motifs, this results in an self-supporting structure of great strength that serves to display products of consistency thick or heavy as containers or soaps, in each of its shelves.

The rack is manufactured with a “C” panel and a load center consists as the first element type rectangular channel or continuous core of double flute made of cardboard corrugated, provided with subsequent slots or guides to the tabs on the back edge of each wrap-around covers or “C” panel, side slots for corner pieces crossbars placed two upside down to hold a tray or shelf with free flap that provides structural strength in each of the side edges also includes a tab that goes into a slot of the wrap-around cover and works as fastener with the same, tray or shelf is also fastened through two corner pieces or crossbars, one on the rear edge and another at the front edge, the tray is placed on these crossbars, this shelf embodiment consists of four trays or shelves. Side flaps of the load center or core is covered each with a wrap-around cover made of cardboard with inner and outer faces, the outer face can be laminated and printed with advertising motifs, inner face is attached to the load center through tabs on edge entering the rear slots or wrap-around core, the inner face of the cover also has slots to accommodate the corner pieces panels and shelves; the external face is fixed by means of adhesive in addition to a flap on the cover edge that is folded inward to give retaining support over the center support. As first step to place the wrap-around covers, is placed internal face staying open the outer face, since corner pieces are placed through the slots in the load center, once attached to the corner pieces panels and trays closes one of the outer faces of the cover, then the other to complete self-supporting structure with increased strength by the conformation of the load center complemented by side wrap-around covers.

FIG. 10 a shows a view of the wrap-around cover (110) panel “C” made of cardboard with an outer face (115) and an inner face (116) separated by a line of die-cut (117) that functions as a hinge that allows folding both faces on one of the flaps of the load center, inner face (116) with slots (112 and 113) that allow the passage of corner pieces or crossbars for attachment of a tray or shelf, trailing edge tabs (118) that inserted into slots in the rear of the load center for attachment of the same inner face, outer face is attached by adhesive to the flaps of the load supported also by the upper flap (114), this outer face can be laminated or printed with advertising motifs.

The FIG. 10b is a frontal view in perspective of the load center continuous core (120) made of corrugated board with a minimum splice of double flute, consists of three vertical rectangular sections separated by two lines of die-cut, a central section (126) provided with slots (123) on the lines of die-cut, where enter edge tabs (118) of the wrap-around cover for attachment of the same, side sections (121 and 122) in the same way as the central section, contain two rows of slots (124 and 125) ordered in a vertical row function as support for corner pieces that holds the tray or shelf on which are placed the goods on display.

FIG. 10c shows support elements of goods, the pair of corner pieces (130) or profiles in the form of “L” made of laminated cardboard placed in the slots in the load center, through the sides of it, but before placement should be placed wrap-around covers inner faces, then enter through the side of the body of the shelf and the wrap-around covers outer faces close. Once attached to the corner pieces is placed on the same tray or shelf (131) made of corrugated board with free flap (132) to provide the same structural strength, located each along the edge of the tray, also has tabs (133) that enter into the slots on the inner side of the wrap-around covers, these tabs help fixing shelves and they function as setting element for the front corner pieces or crossbars.

FIG. 10d shows a view (140) from the center of load (120) with two wrap-around covers (110) placed on the side of the same flaps, shows the inner faces (116) fixation on the die-cut line that divides the center (126) of flaps of the load center (120); inner face (116) is set to match and insert tabs into the corresponding slots (123) (118), inner face slots (141) host the tabs from the tray, elements that cooperates with the slots (112) for the attachment of the same, the outer faces (115) are fixed by means of adhesive and also through upper flap (114) that folds inward to cover the cover of the flaps of the load center.

FIG. 10e is a rear view in perspective of the rack display of the present invention, is shown tray (131), already placed and fastened by means of tabs (133) into the slots on the inner side of the wrap-around cover, rear fastening from the inside of the envelope cover is also displayed on the tabs (118) of the lines of the rear section (126) die-cut face (115) of the wrap-around cover shown open to place the corner pieces through the slots (124) also shows the tab (133) of the tray forming the panel, and the tab as well as attach to tray is positioned to fit the front corner pieces that attaches to said tray.

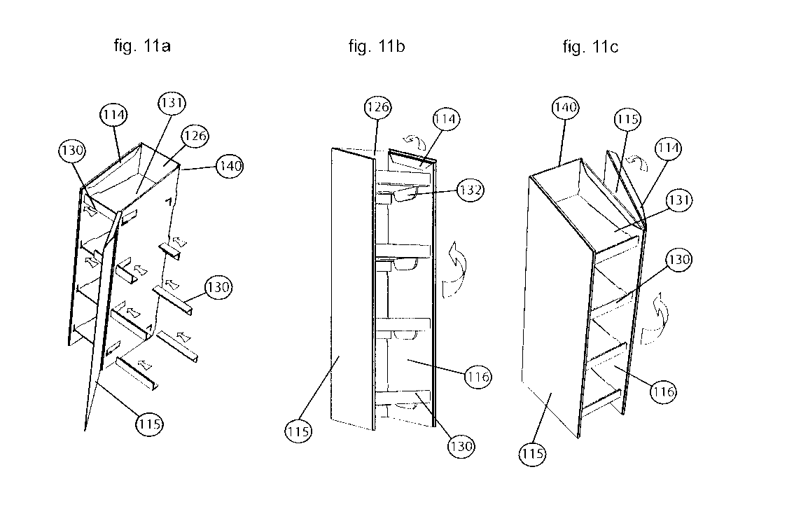

FIGS. 11 a-c, show views in perspective of the rack (140) that shows the process of introduction of corner pieces (130) through the side slots with the outer face (115) of the cover fully open, the corner pieces provide support for tray (131) and along with a section of the rear wall (126) and the lateral flaps define a space for display of goods, the upper flap (114) does not permit the deliberate opening of the external face (115) of the wrap-around cover. Note the position of free flap (132) of the tray located at the lateral edge of the same, with a position vertical provides with increased strength to loads that supports the tray, this flap cooperates with crossbars (130) for support the tray, in addition to the outer faces (116) and (115) of the support panel wrap-around cover, finally resulting in a colorful, lightweight an strength rack display to support loads.

What is claimed is:

1. System of assembly and structure based on corrugated and laminated cardboard consisting of:
at least two panels of corrugated board of preset shape that function as support, built with splice or stacking of at least two sheets of corrugated board with the flute in the axial direction load with outer covers and a medial body of support in which slots of preset shape they receive to the ends of profiles of laminated cardboard to form a self-sustaining as a three-dimensional structure like a bench, chair, desk, base for mattress;
a plurality of laminated cardboard profiles which together function as elements of union with support panels, to form a stable three-dimensional structure that is used for furniture, packaging and display;
a continuous wrap-around cover or panel “C” shaped with an inner and an outer faces with tabs wrapping a load center or panel support to hide the same flute and protect against moisture and wear.

2. Assembly and structuring system based on corrugated and laminated cardboard in accordance with claim 1, characterized also because in one of the embodiments preferred two panels of corrugated board of preset shape are mirror images.

3. Assembly and structuring system based on corrugated and laminated cardboard according to claim 1, characterized in addition because corrugated board with box panels have an outer cover consisting of a sheet of corrugated cardboard or base format without slots.

4. Assembly and structuring system based on corrugated and laminated cardboard, according to claim 1, characterized in addition because in one of the preferred forms, support panels of corrugated cardboard are in a relationship at a right angle with respect to the position of laminated cardboard profiles.

5. Assembly and structuring system based on corrugated and laminated cardboard in accordance with claim 1, characterized in addition because in one of the preferred embodiments, the position of the support panels of corrugated board is in a relationship at an oblique angle to laminated cardboard profiles.

6. Assembly and structuring system based on corrugated and laminated cardboard in accordance with claim 1, characterized in addition because in one of the preferred embodiments, the position of support panels of corrugated cardboard is in a relationship at an oblique angle with respect to each other.

7. Assembly and structuring system based on corrugated and laminated cardboard, according to claim 1, characterized in addition because in one of the preferred embodiments, the position of laminated cardboard profiles are in a relationship at an oblique angle respect each other.

8. Assembly and structuring system based on corrugated and laminated cardboard in accordance with claim 1, characterized in addition because one of the preferred chair bench, and desk is constructed from two parallel vertical panels of corrugated cardboard are image mirror each other, a plurality of perpendicular profiles of laminated cardboard forming the backrests, the seat and front and rear sections of reinforcement.

9. Assembly and structuring system based on corrugated and laminated cardboard, according to claim 1, characterized in addition because one of the preferred embodiments is a base for a mattress that is constructed from two end parallel vertical elongated panels along with an intermediate panel of corrugated cardboard, a plurality of perpendicular laminated cardboard profiles attached to the panels of corrugated cardboard through some slots which together form the basis.

10. Assembly and structuring system based on corrugated and laminated cardboard according to claim 1, characterized in addition because one of the preferred embodiments is a desk with two panels of cardboard corrugated substantially in the form “X” with three profiles that define an upper flat surface horizontal that receives a cover of hard material, six profiles that define two reinforcement tilted frontal surfaces.

11. Assembly and structuring system based on corrugated and laminated cardboard, according to claim 1, characterized in addition because one of the preferred embodiments is a bench with two side panels of support and two intermediate corrugated panels provided with slots to receive a plurality of laminated cardboard profiles to form the backrest with three profiles, the seat with seven profiles and the reinforcement front and rear areas with two profiles each.

12. Assembly and structuring system based on corrugated and laminated cardboard according to claim 1, characterized in addition because one of the preferred embodiments is a chair that consists of two side panels of cardboard corrugated slotted to receive a plurality of profiles of laminated cardboard to form the backrest with three profiles, the with six profiles and the reinforcement front and rear areas with two profiles each surfaces.

13. Assembly and structuring system based on corrugated and laminated cardboard, according to claim 1, characterized in addition because one of the preferred embodiments is a bench consisting of two panels of cardboard corrugated slotted to receive a plurality of laminated cardboard profiles to form the seat with five profiles, the reinforcement front and rear surfaces, each with two profiles.

14. Assembly and structuring system based on corrugated and laminated cardboard in accordance with claim 1, characterized in addition because reinforcement panel consists of a body with “L”-shaped slots, “circular” and “U” channel with straight corner pieces, said intermediate body with a cap of corrugated cardboard on each side bonded by adhesive where at least one has no slots.

15. Assembly and structuring system based on corrugated and laminated cardboard, according to claim 1, characterized in addition because shapes and sizes of the preferred laminated cardboard profiles are “L” shaped squarely with dimensions of 3×3 or 3 in×2 in (7.62 cm×7.62 cm and 7.62 cm×5.08 cm).

16. Assembly and system structure based on corrugated and laminated cardboard in accordance with claim 1, characterized in addition because wrap-around cover, “C” panel protects moisture load panel, hiding the same flute.

17. Assembly and structuring system based on corrugated and laminated cardboard, according to claim 1, characterized in addition because the wrap-around cover provides increased strength to with structures built with corrugated and laminated cardboard.

18. Assembly and structuring system based on corrugated and laminated cardboard, according to claim 1, characterized in addition because the wrap-around cover can be printed with advertising motifs.

19. Assembly and structuring system based on corrugated and laminated cardboard according to claim 1, characterized in addition one of the preferred embodiments is a rack display built with a “C” panel that allows the construction of the same without the use of adhesive and an increased strength.

20. Assembly and structuring system based on corrugated and laminated cardboard in accordance with claim 19, also characterized because of support panels cover is larger than the die-cut layers and has tabs that can be folded in order to hide the corrugated flute.

21. (canceled)
